(19) United States
(12) Patent Application Publication
(10) Pub. No.: US 2012/0002119 A1
(43) Pub. Date: Jan. 5, 2012

(54) Television Apparatus and Electronic Device

(76) Inventors: Nobuhiro Yamamoto, Tokyo (JP); Tsuyoshi Kozai, Tokyo (JP); Takahisa Funayama, Tokyo (JP)

(21) Appl. No.: 13/008,680

(22) Filed: Jan. 18, 2011

(30) Foreign Application Priority Data
Jun. 30, 2010 (JP) 2010-149033

(51) Int. Cl. H04N 5/64

(52) U.S. Cl. 348/836; 348/E05.128

(57) ABSTRACT

According to one embodiment, a television apparatus includes a substrate, a pad, a receiving portion, a coating layer, and an electric component. The pad is formed on a surface of the substrate. A conductive material arranged on the pad flows into the receiving portion while having fluidity. The coating layer is formed by the conductive material flowed into the receiving portion and solidified while covering at least a surface of the pad. The electric component includes a contact terminal pressed against and brought into contact with the coating layer.

### CROSS-REFERENCE TO RELATED APPLICATIONS

This application is based upon and claims the benefit of priority from Japanese Patent Application No. 2010-149033, filed Jun. 30, 2010, the entire contents of which are incorporated herein by reference.

### FIELD

Embodiments described herein relate generally to a television apparatus and an electronic device.

### BACKGROUND

Typically, electronic devices such as television apparatuses are known in which a contact terminal of an electric component is pressed against and brought into contact with a pad formed on a surface of a substrate.

With regard to such electronic devices, surface treatment by plating is sometimes performed on the surface of the pad. However, when the surface treatment is performed on the pad by plating, the number of manufacturing processes is increased. Accordingly, the time and effort for the manufacture increases, and the manufacturing costs may also be increased.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television apparatus functioning as an electronic device according to a first embodiment;

FIG. 2 is an exemplary cross-sectional view of a portion of a substrate and an electric component comprised in the television apparatus in the first embodiment;

FIG. 3 is an exemplary cross-sectional view illustrating a state when a conductive material for forming a coating layer in FIG. 2 is set, in the embodiment;

FIG. 4 is an exemplary cross-sectional view illustrating a state when the coating layer formed of the conductive material for forming the coating layer in FIG. 2 flows into a receiving portion and forms the coating layer, in the first embodiment;

FIG. 5 is an exemplary plan view of a pad comprised in a television apparatus according to a first modification of the first embodiment;

FIG. 6 is an exemplary plan view of a pad comprised in a television apparatus according to a second modification of the first embodiment;

FIG. 7 is an exemplary plan view of a pad comprised in a television apparatus according to a third modification of the first embodiment;

FIG. 8 is an exemplary plan view of a pad comprised in a television apparatus according to a fourth modification of the first embodiment;

FIG. 9 is an exemplary plan view illustrating a state when a conductive material is set on the pad in FIG. 8, in the fourth modification;

FIG. 10 is an exemplary plan view illustrating a state when the conductive material in FIG. 9 flows into a receiving portion, in the fourth modification;

FIG. 11 is an exemplary plan view illustrating a state when a coating layer is formed on the pad in FIG. 8, in the fourth modification;

FIG. 12 is an exemplary plan view of a pad comprised in a television apparatus according to a fifth modification of the first embodiment;

FIG. 13 is an exemplary cross-sectional view of the pad in FIG. 12 and a substrate;

FIG. 14 is an exemplary plan view of a pad comprised in a television apparatus according to a sixth modification of the first embodiment;

FIG. 15 is an exemplary cross-sectional view of a portion of a substrate and an electric component comprised in a television apparatus according to a seventh modification of the first embodiment;

FIG. 16 is an exemplary plan view of a pad comprised in a television apparatus according to an eighth modification of the first embodiment;

FIG. 17 is an exemplary cross-sectional view taken along line XVII-XVII illustrated in FIG. 16, in the eighth modification;

FIG. 18 is an exemplary perspective view of a personal computer functioning as an electronic device according to a second embodiment;

FIG. 19 is an exemplary plan view of a connector functioning as an electronic device according to a third embodiment, and FIG. 19A is an exemplary plan view illustrating a state before a first component and a second component are connected with each other, and FIG. 19B is an exemplary plan view illustrating a state after the first component and the second component are connected;

FIG. 20 is an exemplary perspective view of a first component of a connector functioning as an electronic device according to a fourth embodiment;

FIG. 21 is an exemplary cross-sectional view of a portion of a second component of the connector functioning as the electronic device, in the fourth embodiment;

FIG. 22 is an exemplary cross-sectional view of a portion of the connector functioning as the electronic device in the fourth embodiment; and

FIG. 23 is an exemplary perspective view of a magnetic disk device functioning as an electronic device according to a fifth embodiment.

### DETAILED DESCRIPTION

In general, according to one embodiment, a television apparatus comprises a substrate, a pad, a receiving portion, a coating layer, and an electric component. The pad is formed on a surface of the pad. A conductive material arranged on the pad flows into the receiving portion while having fluidity. The coating layer is formed by the conductive material flowed into the receiving portion and solidified while covering at least a surface of the pad. The electric component comprises a contact terminal pressed against and brought into contact with the coating layer.

According to another embodiment, a television apparatus comprises a substrate, a pad, a coating layer, and an electric component. The substrate is arranged in a housing. The pad is formed on a surface of the substrate. The coating layer is formed by a conductive material covering at least a surface of the pad. The electric component is arranged on the surface of the substrate and comprises a contact terminal pressed against and brought into contact with the coating layer. The pad comprises a plurality of small pad portions separated from each other by a spacing, and the coating layer is divided and arranged on the small pad portions.

According to still another embodiment, an electronic device comprises a substrate, a pad, a receiving portion, a coating layer, and an electric component. The pad is formed on a surface of the substrate. A conductive material arranged on the pad flows into the receiving portion while having fluidity. The coating layer is formed by the conductive material flowed into the receiving portion and solidified while covering at least a surface of the pad. The electric component comprises a contact terminal pressed and brought into contact with the coating layer.

Embodiments and modifications described below include identical elements. Thus, in the following, the identical elements are referred to by the same reference numerals, and repetitive explanations thereof are omitted.

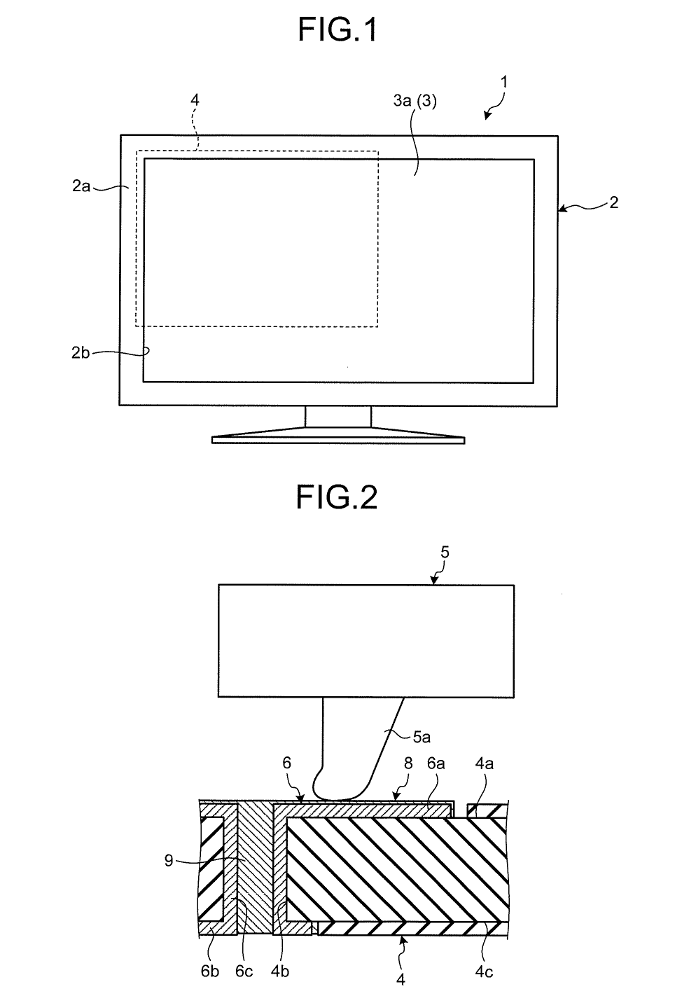

As illustrated in FIG. 1, an electronic device 1 of a first embodiment is formed as a television apparatus and has a rectangular appearance when viewed from the front (in a plan view with respect to the front face). The electronic device 1 comprises a housing 2, a display panel 3 (such as a liquid crystal display (LCD)) that is a display device (display) having a display screen 3a exposed anteriorly from an opening 2b formed on a front face 2a of the housing 2, and a substrate 4 on which electronic components (not illustrated) are mounted. The display panel 3 and the substrate 4 are fixed to the housing 2 with screws or the like (not illustrated).

The display panel 3 is formed in the shape of a thin and flat rectangular parallelepiped in the front-back direction (perpendicular direction to the plane of paper of FIG. 1). The display panel 3 is configured to receive picture signals from a picture signal processing circuit (not illustrated), which is one of the control circuits (not illustrated) configured with the electronic components mounted of the substrate 4. Then, the display panel 3 displays stationary pictures or motion pictures on the display screen 3a that is positioned in the front. Apart from the picture signal processing circuit, the control circuits in the electronic device 1 functioning as the television apparatus comprises a tuner, a high-definition multimedia interface (HDMI) signal processor, an audio video (AV) input terminal, a remote control signal receiver, a controller, a selector, an on-screen display interface, a memory (such as a read only memory (ROM), a random access memory (RAM), and a hard disk drive (HDD)) , and an audio signal processing circuit, none of which is illustrated. The substrate 4 is housed behind the display panel 3 inside the housing 2. Meanwhile, the electronic device 1 has built-in amplifiers or speakers (not illustrated) for the purpose of audio output.

As illustrated in FIG. 2, for example, the housing 2 comprises therein the substrate 4 formed as a printed circuit board and an electric component 5 arranged on a surface 4a of the substrate 4. The electric component 5 comprises a contact terminal 5a pressed against and brought into contact with a pad 6 formed on the surface 4a. The electric component 5 is engaged or joined with the substrate 4, the housing 2, and/or the like, at a portion other than a portion where the contact terminal 5a and the pad 6 come into contact with each other. A pressing force is applied between the contact terminal 5a and the pad 6.

The pad 6 has an outer layer 6a made of a copper foil and the like formed on the surface 4a of the substrate 4. The pad 6 is formed in, for example, a rectangular shape, an oblong shape, or an oval shape in a plan view with respect to the surface 4a of the substrate 4 (when viewed from above in FIG. 2). The pad 6 is electrically connected to a conductive portion (not illustrated) that is a part of a circuit provided on the surface 4a or a rear face 4c of the substrate 4, or the inside of the substrate 4.

The substrate 4 comprises a through-hole 4b that is a concave opened in the pad 6. An outer layer 6b made of a copper foil or the like is formed at a periphery of an opening of the through-hole 4b on a side of the rear face 4c of the substrate 4. An inner peripheral portion 6c made of a conducting body electrically connected to both the outer layer 6a on the side of the surface 4a and the outer layer 6b on the side of the rear face 4c is formed on an inner peripheral surface of the through-hole 4b. In other words, in the present embodiment, the inner peripheral portion 6c is formed as a so-called through-hole via. The inner peripheral portion 6c is formed, for example, by plating process.

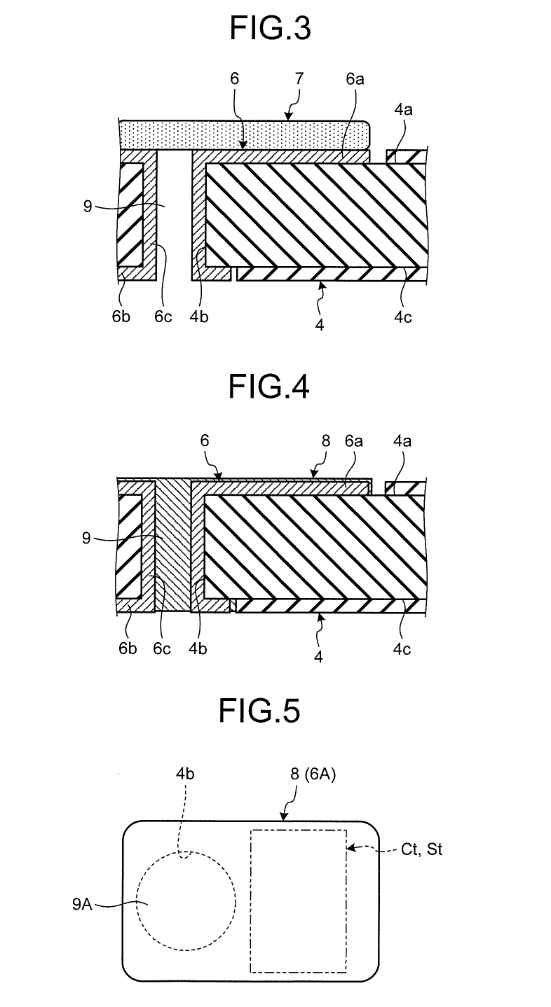

The surface of the pad 6 is coated by a coating layer 8 that is a relatively thin film of a conductive material 7. The conductive material 7, for example, is a solder alloy (solder paste) with a thermoplastic property. A method for forming the coating layer 8 is described with reference to FIGS. 3 and 4.

As illustrated in FIG. 3, the conductive material 7 (such as a solder paste) with the thermoplastic property is set on the pad 6. More specifically, for example, the conductive material 7 is placed on an entire area of the outer layer 6a of the pad 6 at a fixed thickness so as to block the through-hole 4b. In the present embodiment, the conductive material 7 does not have fluidity at the time when it is set on the pad 6.

In a reflow process for surface mounting electronic components and the like (not illustrated) on the substrate 4 by soldering, when the substrate 4 is heated, the solder paste that is the conductive material 7 with the thermoplastic property melts. Then, due to the gravity, the intermolecular force acted between the outer layer 6a and the inner peripheral portion 6c and the melted conductive material 7 having fluidity, and/or the like, as illustrated in FIG. 4, the conductive material 7 flows into the through-hole 4b that is a concave in a receiving portion 9. In this manner, the flattened and thinned coating layer 8 is formed on the outer layer 6a. As illustrated in FIG. 4, the amount of the conductive material 7, the inner diameters of the through-hole 4b and the inner peripheral portion 6c, and the like are appropriately set, so as to prevent the conductive material 7 flowing into the through-hole 4b from reaching the side of the rear face 4c of the substrate 4 or leaking therefrom. After performing the reflow process, the substrate 4 is cooled, and the conductive material 7 is solidified in the state illustrated in FIG. 4, or in other words, while covering the pad 6. Accordingly, the coating layer 8 illustrated in FIGS. 2 and 4 is formed.

In the present embodiment, without carrying out the plating process, the coating layer 8 of a relatively thin film can be obtained from the conductive material 7 which covers the surface of the pad 6. Accordingly, it becomes possible to prevent increase in the manufacturing time and effort, and to prevent increase in the manufacturing costs due to the plating process on the surface of the pad 6.

It is difficult to form the thin coating layer 8 by simply arranging the conductive material 7 on the pad 6. Ina liquid state, the conductive material 7 expands in a spherical manner on the surface of the pad 6 by the surface tension. Accordingly, if the conductive material 7 is solidified in this case, the thickness (height) of the coating layer 8 varies depending on the location. Because the height of the coating layer 8 is larger at a center of the pad 6, the contact terminal 5a can easily move outside the pad 6. In the present embodiment on the other hand, the coating layer 8 that is a relatively thin film can be formed by pouring the conductive material 7 into the receiving portion 9. It also becomes possible to easily prevent the variation in the thickness. The coating layer 8 of the conductive material 7 according to the present embodiment is not intended to melt-bonding the pad 6 with the terminal of the electric component 5, but is intended to form a coating layer of the conductive material 7 on the surface of the pad 6 that is a contact object of the contact terminal 5a of the electric component 5 so as to for example increase the reliability and durability of the pad 6.

In the present embodiment, the concave (such as the through-hole 4b in the present embodiment) is formed in the receiving portion 9. Accordingly, it is possible to easily form the coating layer 8 thinner, because the conductive material 7 having fluidity can surely be poured into the receiving portion 9. Taking into account how the conductive material 7 that flows on the pad 6 spreads out due to its wettability, it is preferable that a connecting region with the circuit is placed inside (in other words, the inner peripheral portion 6c and the like) of the substrate 4 or on the side of the rear face 4c (in other words, on the outer layer 6b and the like) of the substrate 4.

In a first modification illustrated in FIG. 5, a pad 6A is formed in a rectangular shape in a plan view, and the through-hole 4b that is a concave in a receiving portion 9A is opened at one end of the pad 6A in a longitudinal direction of the pad 6A. In the present modification, a region opposite from the through-hole 4b is a set region St of the conductive material 7 (see FIG. 3) before flowing into the receiving portion 9A, and the region is also a contact region Ct of the contact terminal 5a (see FIG. 2). With such structure, the same effects as those in the first embodiment can be obtained. In the present modification, the contact region Ct can be formed on a relatively flat portion of the coating layer 8 on the pad 6A. Accordingly, it is advantageous when the variation of the contact terminal 5a with respect to the coating layer 8 on the pad 6A in the place direction (direction along the surface 4a) of the substrate 4 is comparatively large due to manufacture error and the like.

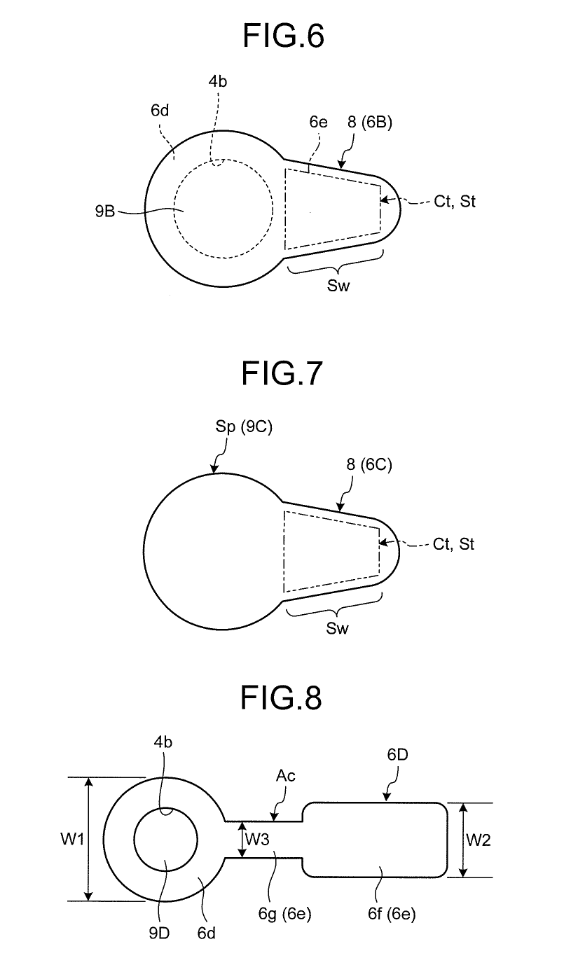

In a second modification illustrated in FIG. 6, a pad 6B has a circular portion 6d formed at a periphery of the through-hole 4b that is a concave in a receiving portion 9B and a projection portion 6e projected outward from the circular portion 6d on the surface 4a of the substrate 4. In the present modification, the projection portion 6e is the set region St of the conductive material 7 (see FIG. 3) before flowing into the receiving portion 9B, and also the contact region Ct of the contact terminal 5a (see FIG. 2). The projection portion 6e becomes narrower as it extends in the radial direction from the circular portion 6d. In other words, in the present modification, the projection portion 6e comprises a wide region Sw. The wide region Sw has an increasing width from a region at the end of the projection portion 6e that is a part of the set region St to the side of the receiving portion 9B. In this manner, by forming the wide region Sw, it is possible to easily make the conductive material 7 flowing from the set region St to the receiving portion 9B. Accordingly, it is possible to prevent the thickness of the coating layer 8 from varying depending on the location.

In a third modification illustrated in FIG. 7, a pad 6C has the set region St and a receiving portion 9C both formed in flat plate shapes. In other words, in the present modification, the pad 6C does not have a concave as the receiving portion 9C, but has an extended region Sp extending outward from the set region St in a planar manner. In this manner, by forming the receiving portion 9C as the extended region Sp, it is possible to prevent increase in the manufacturing time and effort, and to prevent increase in the manufacturing costs, in comparison to the case when a through-hole is formed. In the present modification, the pad 6C also has the wide region Sw with increasing width from the set region St to the extended region Sp that is the receiving portion 9C.

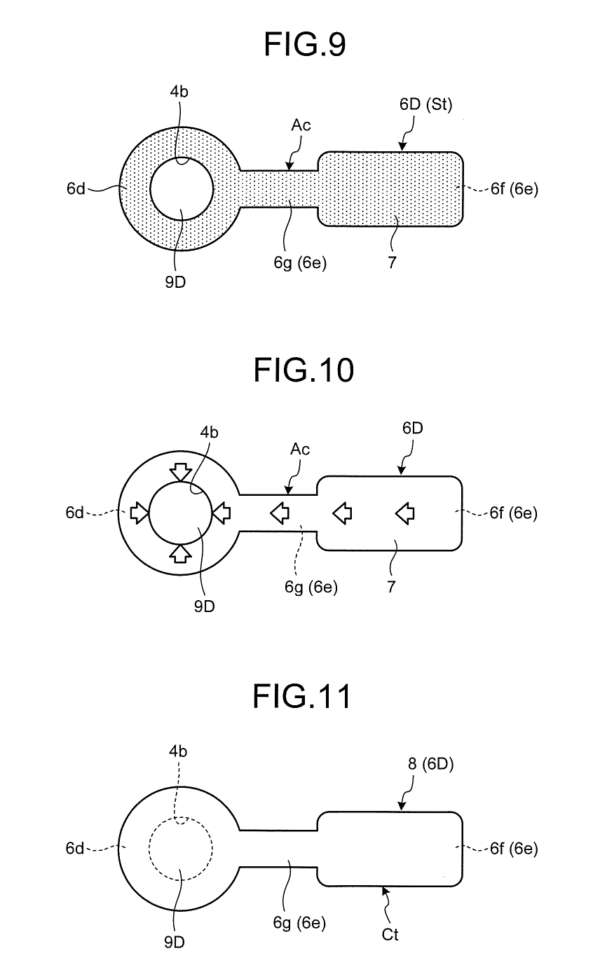

In a fourth modification illustrated from FIGS. 8 to 11, a pad 6D, as illustrated in FIG. 8, has the circular portion 6d formed at the periphery of the through-hole 4b that is a concave in a receiving portion 9D, and the projection portion 6e projected outward from the circular portion 6d on the surface 4a of the substrate 4. The projection portion 6e has a rectangular portion 6f and a strip-shaped portion 6g connecting the circular portion 6d and the rectangular portion 6f. In the present modification, as illustrated in FIG. 9, the thermoplastic conductive material 7 (such as a solder paste) is set over the entire area of the pad 6D. In other words, in the present modification, the entire pad 6D is the set region St. As illustrated in arrows in FIG. 10, the conductive material 7 melted in the reflow process flows into the through-hole 4b. At this time, in the present modification, as illustrated in FIG. 8, a width W3 of the strip-shaped portion 6g is smaller than a width W1 of the circular portion 6d that is the receiving portion 9D and a width W2 of the rectangular portion 6f that is a part of the set region St. In other words, the conductive material 7 is prevented from flowing from the receiving portion 9D to the side of the rectangular portion 6f that is a part of the set region St (reverse flow), because the strip-shaped portion 6g corresponding to a narrow region Ac becomes a flow resistance of the conductive material 7. In this manner, by preventing the reverse flow of the conductive material 7 by the narrow region Ac, the variation in the thickness of the coating layer 8 can be prevented. The substrate 4 is then cooled, and the coating layer 8 that is a relatively thin film of the conductive material 7 is formed over the entire area of the pad 6D so as to block the through-hole 4b. Although not illustrated, the width of the strip-shaped portion 6g that is the narrow region Ac in the present modification can be set so as to gradually increase from the receiving portion 9D to the side distantly positioned from the receiving portion 9D. In this case, the strip-shaped portion 6g functions as the narrow region Ac and the wide region Sw. Accordingly, it is possible to easily prevent the thickness of the coating layer 8 from fluctuating depending on the location.

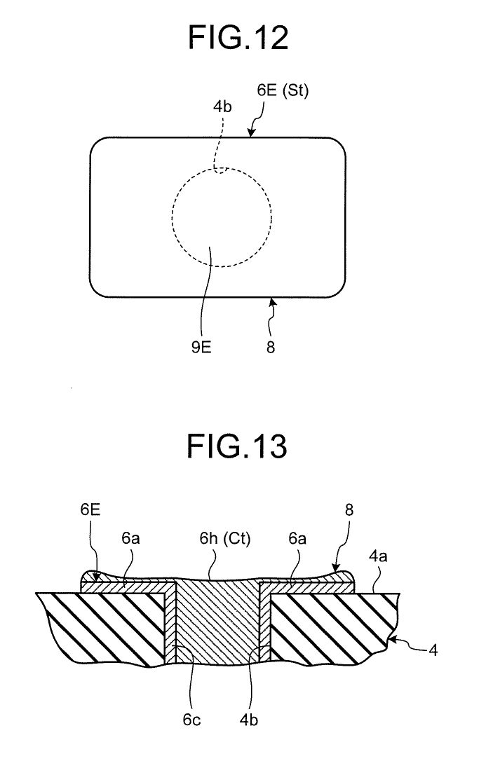

In a fifth modification illustrated in FIGS. 12 and 13, the through-hole 4b that is a concave in a receiving portion 9E is opened at a center of a pad 6E that has a rectangular shape in a plan view. In the present modification, the conductive material 7 is set over the entire area of the pad 6E, and the conductive material 7 (see FIG. 3) heated in the reflow process and turned into a liquid state flows into the through-hole 4b. Accordingly, the coating layer 8 that is a relatively thin film of the conductive material 7 is formed on the pad 6E. In the present modification, an upper surface 6h of a portion formed by the conductive material 7 flowing into the through-hole 4b that is a concave, is the contact region Ct of the contact terminal 5a (see FIG. 2). Consequently, the diameter of the through-hole 4b is set relatively large. In this case, the upper surface 6h is formed in a concave shape in which the center is the deepest by the surface tension of the conductive material 7 having fluidity. As a result, the contact terminal 5a can be guided to the center of the contact region Ct. It is preferred that a radius of curvature of the upper surface 6h at the cross-section perpendicular to the surface 4a of the substrate 4 is larger than a radius of curvature of the contact terminal 5a at the cross-section of the same of the end portion thereof.

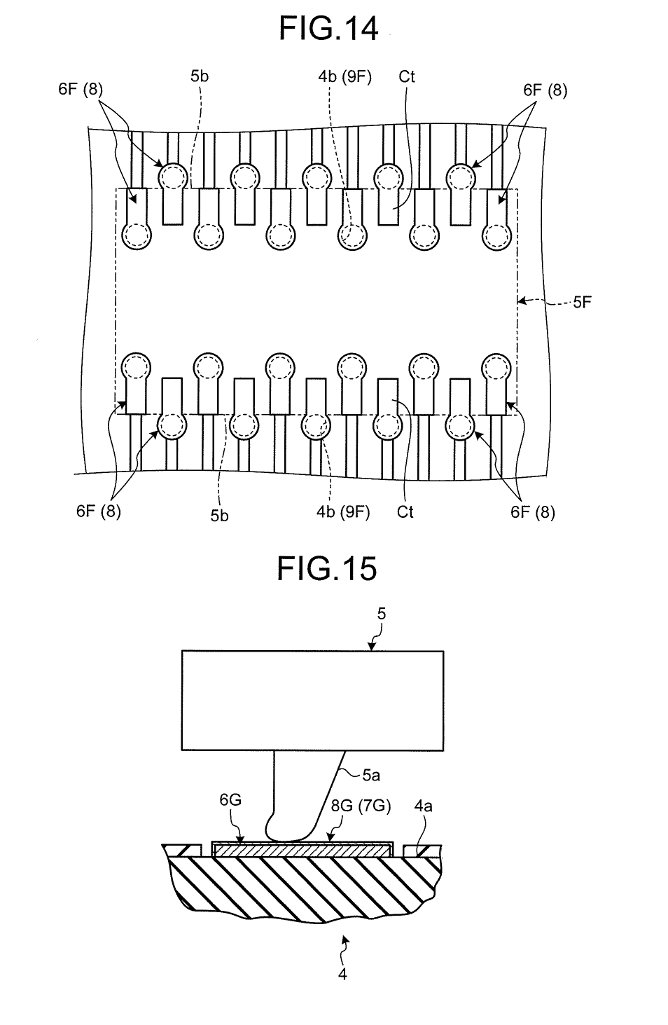

In a sixth modification illustrated in FIG. 14, a plurality of pads 6F is provided so as to correspond to the plurality of contact terminals 5a (see FIG. 2) of an electric component 5F. The pads 6F are arranged in rows. Each of the rows are along each of a pair of long sides 5b and 5b facing each other. The long sides 5b and 5b are disposed at the peripheries of the electric component 5F formed in a rectangular shape in a plan view. Each of the pads 6F is formed in an elongated shape, and the through-hole 4b that is a concave in a receiving portion 9F is formed at one end side of the pad 6F in the longitudinal direction thereof . The contact region Ct that is on the other end side of the pad 6F in the longitudinal direction thereof is arranged in rows along the long side 5b at the position facing each of the contact terminals 5a of the electric component 5F. The width the one end side of the pad 6F in the longitudinal direction thereof to which the receiving portion 9F is formed is larger than the width of the other end side of the pad 6F in the longitudinal direction thereof to which the contact region Ct is formed. In the rows of the pads 6F, the pads 6F are alternatively arranged between a pad 6F in which the receiving portion 9F is arranged on one side in a width direction (vertical direction in FIG. 14) of each of the rows and a pad 6F in which the receiving portion 9F is arranged on other side in a width direction of the each of the rows. With such structure and arrangement, the regions in which the width of the pad 6F is larger (in the present modification, the side on which the receiving portion 9F is formed) are prevented from being arranged in a row, thereby preventing the regions having the large width from being arranged adjacent to each other. Accordingly, it becomes possible to prevent a short circuit between the coating layers 8 formed on the pads 6F. It also becomes possible to obtain effects such as the arrangement density of the pads 6F can be enhanced and effects such as the diameter of the through-hole 4b that is a concave in the receiving portion 9F can be further increased, while preventing a short circuit between the coating layers 8.

In a seventh modification illustrated in FIG. 15, a pad 6G is covered by a coating layer 8G made of a conductive material 7G (such as a conductive adhesive) which has fluidity at ambient temperature. The conductive material 7G having relatively low viscosity spreads along the surface of the pad 6G and is dried to be solidified. Accordingly, the coating layer 8G that is a relatively thin film is formed. With this conductive material 7G, it is also possible to obtain the same structure and the same effects as those in the first embodiment or in the first to the sixth modifications.

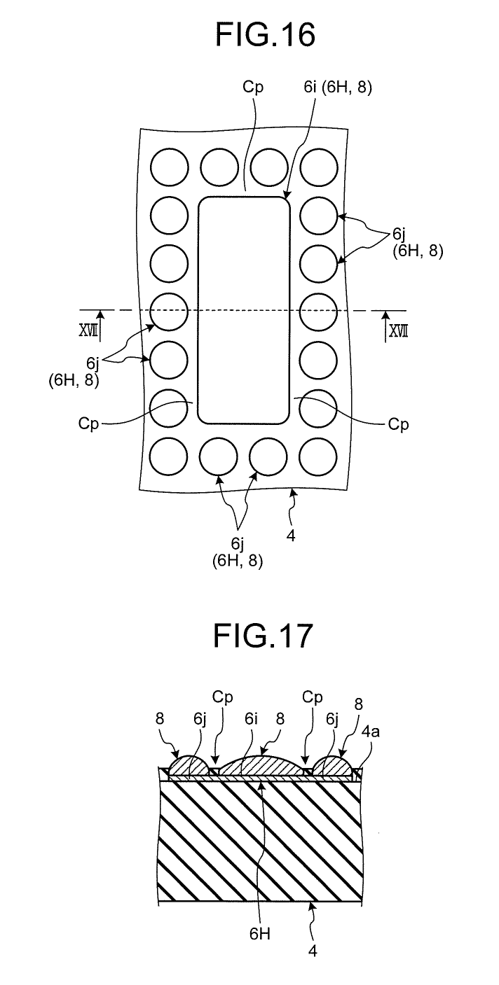

In an eighth modification illustrated in FIGS. 16 and 17, a pad 6H has a plurality of small pad portions 6i and 6j divided and spaced apart from one another. The coating layer 8 is divided and spaced apart on the small pad portions 6i and 6j . A group of the small pad portions 6i and 6j are electrically connected to each other via a rear face, an inside, or the like of the substrate 4, and functions as a single pad 6H. In the present modification, as an example, the pad 6H comprises the small pad portion 6i in a rectangular shape relatively large in size and the small pad portions 6j in a relatively small size arranged so as to surround the periphery of the small pad portion 6i.

In the present modification, as illustrated in FIG. 17, each of the coating layers 8 formed on the small pad portions 6i and 6j expands in a curved surface manner. However, because the pad 6H is segmented into the small pad portions 6i and 6j, a concave Cp is formed between the small pad portions 6i and 6j. Accordingly, the contact terminal 5a (see FIG. 2) can be fitted into the concave Cp. Consequently, each of the small pad portions 6i functions as an engagement mechanism, thereby obtaining effects in which the contact terminal 5a does not easily move outside the pad 6H. With the present modification, it is also possible to obtain the coating layer 8 of a relatively thin film by the conductive material 7 for covering the surface of the pad 6H without carrying out the plating process. As a result, it becomes possible to prevent increase in the manufacturing time and effort, and to prevent increase in the manufacturing costs caused by carrying out the plating process on the surface of the pad 6H.

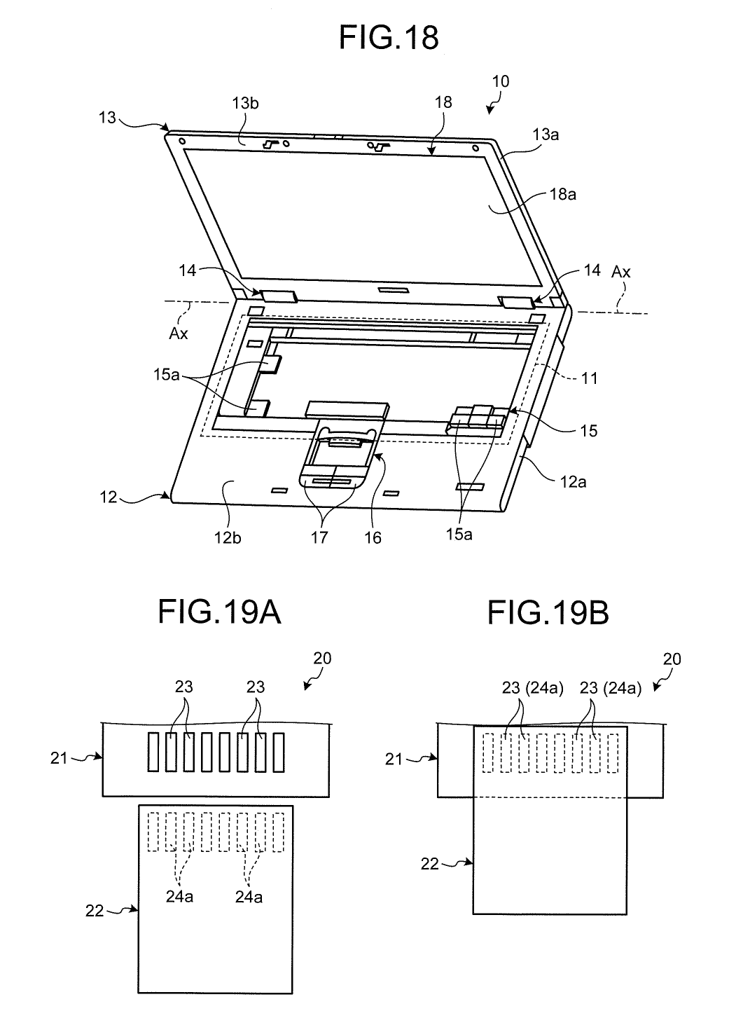

As illustrated in FIG. 18, an electronic device 10 according to a second embodiment is formed as a so-called notebook sized personal computer, and comprises a rectangular and flat first main body 12 and a rectangular and flat second main body 13. The first main body 12 and the second main body 13 are connected in a relatively rotatable manner around a rotation axis Ax via a hinge mechanism 14 between an open state illustrated in FIG. 18 and a folded state (not illustrated).

In the first main body 12, a keyboard 15, a pointing device 16, click buttons 17, and the like functioning as input operation modules are arranged in an exposed manner on a front face 12b that is the external face of a housing 12a. In the second main body 13, a display panel 18 that is a display device (component) is arranged in an exposed manner on a front face 13b that is the external face of a housing 13a. The display panel 18, for example, is formed as a liquid crystal display (LCD). In an open state of the electronic device 10, the keyboard 15, the pointing device 16, the click buttons 17, and a display screen 18a of the display panel 18 are exposed to outside. In such a state, a user is able to perform operations. In contrast, in a folded state, the front faces 12b and 13b face each other from up close in such a way that the keyboard 15, the pointing device 16, the click buttons 17, the display panel 18, and the like are hidden by the housings 12a and 13a. In FIG. 11, only a part of keys 15a of the keyboard 15 is illustrated.

A substrate 11 the same as that in the first embodiment or in the first to the eighth modifications is housed in the housing 12a of the first main body 12 or the housing 13a of the second main body 13 (in the present embodiment, only in the housing 12a).

The display panel 18 receives display signals from control circuits (not illustrated) configured by the electronic components mounted on the substrate 11 and displays stationary pictures or motion pictures. The control circuits in the electronic device 10 include a control module, a memory module (such as a read only memory (ROM), a random access memory (RAM), or a hard disk drive (HDD)), an interface circuit, and various controllers. Meanwhile, the electronic device 10 also has built-in speakers (not illustrated) for the purpose of audio output.

Although not illustrated, a pad having the coating layer illustrated in the first embodiment or in the first to the eighth modifications and an electric component comprising a contact terminal pressed against and brought into contact with the pad may be formed on the substrate 11. Accordingly, with the electronic device 10 according to the second embodiment, it also becomes possible to obtain the same effects as those in the first embodiment and in the first to the eighth modifications.

As illustrated in FIGS. 19A and 19B, a connector functioning as an electronic device 20 according to a third embodiment comprises a first substrate 21 that is a first component and a second substrate 22 that is a second component. A plurality of pads 23 is formed on the first substrate 21 and a contact terminal 24a on the second substrate 22 is pressed against and brought into contact with each of the pads 23. In the present embodiment, the second substrate 22 that is the second component corresponds to the electric component.

The pads 23 according to the present embodiment can be formed as the pads 23 having the coating layer (not illustrated) of the first embodiment or of the first to the eighth modifications. Accordingly, with the electronic device 20 according to the present embodiment, it is also possible to obtain the same effects as those in the first embodiment and in the first to the eighth modifications.

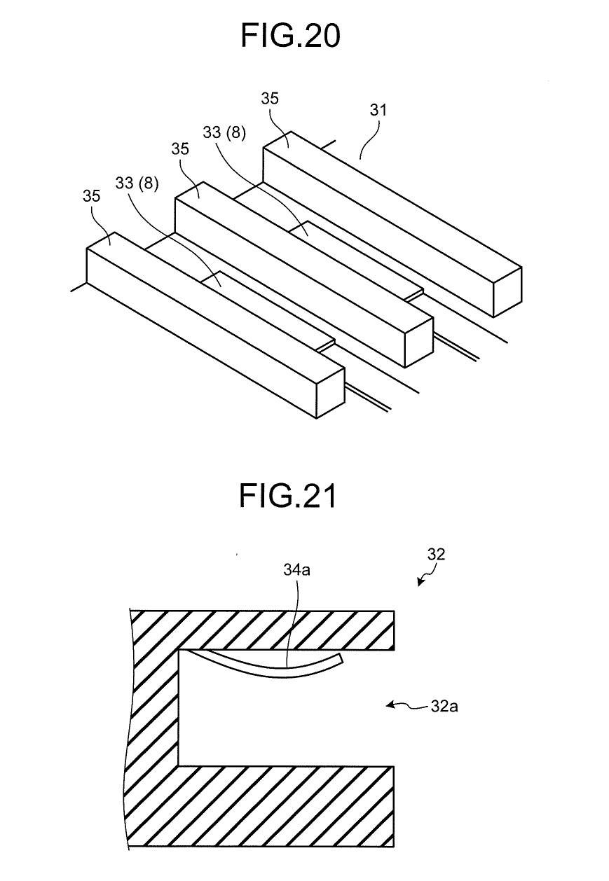

As illustrated in FIGS. 20 to 22, a connector functioning as an electronic device 30 according to a fourth embodiment comprises a substrate 31 that is a first component and a female connector 32 that is a second component. A plurality of pads 33 is formed on the substrate 31, and a contact terminal 34a of the female connector 32 is pressed against each of the pads 33. In the present embodiment, the female connector 32 that is the second component corresponds to the electric component.

As illustrated in FIG. 20, the pads 33 formed in an elongated manner are arranged with a spacing therebetween on the substrate 31 in a direction perpendicular to the longitudinal direction of the pads 33. The coating layer 8 made of the conductive material 7 may be formed on each of the pads 33 by the method of the first embodiment and in the first to the eighth modifications. In the example in FIG. 20, the coating layer 8 is formed in a relatively thin and flat manner.

As illustrated in FIG. 20, a barrier 35 projecting upward from the substrate 31 is formed between the pads 33. In the example in FIG. 20, the width and the height of the barrier 35 are fixed, and the barrier 35 extends in an elongated manner in the longitudinal direction of the pad 33.

As illustrated in FIG. 21, a concave 32a for receiving the substrate 31 is formed on the female connector 32. A contact terminal 34a that comes into contact with the pad 33 is formed at an upper portion of the concave 32a. The contact terminal 34a is elastically pressed against the pad 33 on the substrate 31 inserted into the concave 32a.

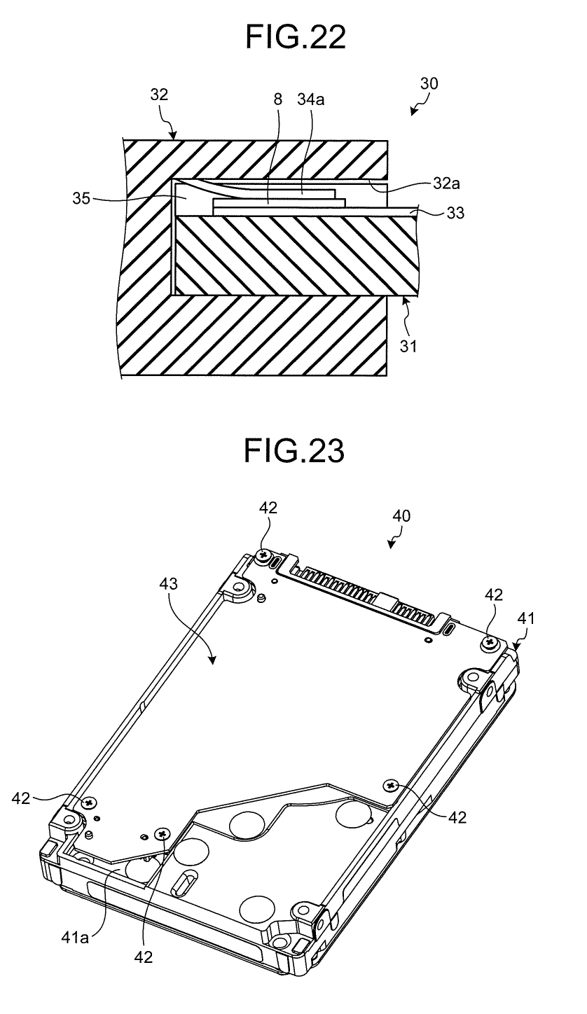

As illustrated in FIG. 22, when the substrate 31 is inserted into the concave 32a, the barrier 35 formed on the substrate 31 divides the space in the concave 32a into a plurality of small chambers for each pad 33. When the conductive material 7 for forming the coating layer 8 includes metal, whiskers may grow due to crystallization of the metal. However, in the present embodiment, because the barrier 35 is formed, it is possible to easily prevent a short circuit between the pads 33 caused by the whiskers.

As illustrated in FIG. 23, an electronic device according to a fifth embodiment is formed as a magnetic disk device 40. The magnetic disk device 40 comprises a housing 41 in the shape of a flat rectangular parallelepiped for housing components such as a magnetic disk (not illustrated) and a substrate (printed circuit board) 43 attached to the housing 41 with fastening members such as screws 42.

The substrate 43 is disposed on an upper wall 41a of the housing 41. A film insulation sheet (not illustrated) is interposed between the substrate 43 and the upper wall 41a. In the present embodiment, a rear face when viewed along the line of sight of the substrate 43 in FIG. 23, or in other words, a rear face (not illustrated) of the substrate 43 facing the upper wall 41a, is a mounting surface on which a plurality of electronic components are mounted. A wire pattern (not illustrated) is formed on the surface and the rear face of the substrate 43. The electronic components can also be mounted on the surface of the substrate 43.

Although not illustrated, a pad having the coating layer illustrated in the embodiments or the modifications and an electric component comprising a contact terminal pressed against and brought into contact with the pad may be formed on the substrate 43. Accordingly, with the magnetic disk device 40 functioning as the electronic device according to the present embodiment, it is also possible to obtain the same effects as those in the embodiments and the modifications.

Although the embodiments are described, embodiments are not limited thereby, and various modifications may be possible. For example, the electronic device can be realized as other than the television apparatus and a notebook PC. Furthermore, the specifications (including the structure, shape, size, length, depth, thickness, cross-section, weight, number, material, arrangement, position, and/or the like) of the substrate, the electric component, the pad, the receiving portion, the coating layer, the contact terminal, the concave, the set region, the extended region, the narrow region, the wide region, the contact region, the small pad portion, the barrier, and/or the like can be suitably modified. As an example, the concave maybe a bottomed hole instead of the through-hole. The receiving portion may have the concave and the extended region. The contact terminal may be a terminal on which a flat contact surface is formed. The planar shape of the pad may be modified into various shapes. The barrier may be formed on the side of the electric components.

Thus, according to the embodiments and the modifications, it is possible to provide a television apparatus and an electronic device in which a coating layer is formed on a surface of a pad with which a contact terminal is pressed against and brought into contact without carrying out a plating process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television apparatus comprising:
a substrate;
a pad formed on a surface of the substrate;
a receiving portion into which a conductive material arranged on the pad flows while having fluidity;
a coating layer formed by the conductive material flowed into the receiving portion and solidified while covering at least a surface of the pad; and
an electric component comprising a contact terminal pressed against and brought into contact with the coating layer.

2. The television apparatus of claim 1, wherein the receiving portion comprises a concave portion formed in the pad or the substrate.

3. The television apparatus of claim 1, wherein
the pad comprises a set region in which the conductive material before flowing into the receiving portion is set and an extended region extended toward outside from the set region in a planar manner, and
the receiving portion is the extended region.

4. The television apparatus of claim 1, wherein the pad comprises a narrow region between the receiving portion and a set region in which the conductive material before flowing into the receiving portion is set.

5. The television apparatus of claim 1, wherein the pad comprises a wide region between the receiving portion and a set region in which the conductive material before flowing into the receiving portion is set, the wide region having a width increasing from the set region to the receiving portion.

6. The television apparatus of claim 2, wherein an upper surface of a portion into which the conductive material flows into the concave portion is a contact region of the contact terminal.

7. The television apparatus of claim 1, wherein
a plurality of the pads is arranged in a row with a spacing therebetween on the substrate, and in the row of the pads,
the receiving portion is arranged at one end side of each of the pads in a longitudinal direction thereof in a plan view with respect to the surface of the substrate, a width of the one end side of each of the pads in the longitudinal direction is larger than that of other end side, and
the pads are alternatively arranged between a pad in which the receiving portion is arranged at one side in a width direction of the row of the pads and a pad in which the receiving portion is arranged at other side in the width direction of the row of the pads.

8. A television apparatus comprising:
a substrate arranged in a housing;
a pad formed on a surface of the substrate;
a coating layer formed by a conductive material covering at least a surface of the pad; and
an electric component arranged on the surface of the substrate and comprising a contact terminal pressed against and brought into contact with the coating layer, wherein
the pad comprises a plurality of small pad portions separated from each other by a spacing, and the coating layer is divided and arranged on the small pad portions.

9. An electronic device comprising:
a substrate;
a pad formed on a surface of the substrate;
a receiving portion into which a conductive material arranged on the pad flows while having fluidity;
a coating layer formed by the conductive material flowed into the receiving portion and solidified while covering at least a surface of the pad; and
an electric component comprising a contact terminal pressed and brought into contact with the coating layer.

10. The electronic device of claim 9, wherein
a plurality of the pads on which the coating layer is formed is arranged on the substrate with a spacing therebetween, and
the electric component or the substrate comprises a barrier arranged between the adjacent pads.
